(19) United States
(12) Patent Application Publication
(10) Pub. No.: US 2023/0358939 A1
(43) Pub. Date: Nov. 9, 2023

(54) POLARIZATION ALTERATION DEVICE AND METHOD FOR ADJUSTING THE POLARIZATION OF AN OPTICAL WAVE

(71) Applicant: Max-Planck-Gesellschaft zur Förderung der Wissenschaften e.V., München (DE)

(72) Inventors: Pascal Del'Haye, Erlangen (DE); Niall Moroney, Erlangen (DE); Leonardo Del Bino, Erlangen (DE); Shuangyou Zhang, Erlangen (DE)

(21) Appl. No.: 18/353,989

(22) Filed: Jul. 18, 2023

Related U.S. Application Data
(63) Continuation of application No. PCT/EP2021/051953, filed on Jan. 28, 2021.

(51) Int. Cl. G02B 5/30

(52) U.S. Cl. CPC G02B 5/3083

(57) ABSTRACT

A polarization alteration device includes a resonator cavity having a resonance mode at a resonance wavelength and a linewidth. The resonator is configured to exhibit no intensity-independent birefringence or an intensity-independent birefringence, whose effect on a light wave confined in the resonator cavity is smaller than the linewidth of the resonance mode. The polarization alteration device is configured to exhibit a Kerr nonlinearity adapted to generate an additional polarization component due to symmetry breaking for a light wave confined in the resonator cavity having a light intensity exceeding a threshold intensity. The polarization direction of the additional polarization component is orthogonal to an initial polarization component of the light wave coupled into the resonator cavity. A polarization control device, a polarization sensor, a method for adjusting the polarization of a light wave and a method for sensing a change of a polarization of a light wave are further disclosed.

### CROSS REFERENCE TO RELATED APPLICATIONS

This application is a continuation application of international patent application PCT/EP2021/051953, filed on Jan. 28, 2021 and designating the U.S., which is hereby incorporated by reference in its entirety.

### TECHNICAL FIELD

Examples of the disclosure relate to a polarization alteration device, a polarization control device, a polarization sensor, an electrooptical chip, methods for adjusting the polarization of an optical wave and a method for sensing a change of a polarization direction of a light wave. The disclosure, thus, relates to the fields of photonics and optical communication.

### BACKGROUND

Photonics is seen as a key enabling technology for optical communication and data processing. Photonics intends to provide techniques for data communication and data processing, as well as computing applications, based on photons and light as information carrier, instead of conventionally used electric currents and electronic circuits. Such techniques require ways to control, switch and/or sense parameters of an optical wave in a highly sensitive manner. Besides, using photonics for such applications will be facilitated by a miniaturization of devices for setting up the required optical networks, in particular devices for controlling and switching properties of the light waves used for carrying and processing information. The goal of said miniaturization is an integration of such devices in a chip, i.e., an integrated circuit, similar to conventional electronic chips and integrated circuits. One parameter of an optical wave to be controlled or switched may be the polarization of said optical wave.

### SUMMARY

The disclosure thus addresses the technical problem of providing devices and methods for controlling, switching and/or sensing the polarization of an optical wave in a highly sensitive manner.

This problem is solved by devices and methods having the features specified in the respective independent claims. Preferred examples are specified in the dependent claims and in the description.

One example of the disclosure relates to a polarization alteration device, comprising a resonator cavity having a resonance mode at a resonance wavelength and a linewidth. The resonator is configured to exhibit no intensity-independent birefringence or an intensity-independent birefringence, whose effect on a light wave confined in the resonator is smaller than the linewidth of the of the resonance mode. The resonator is further configured to exhibit a Kerr nonlinearity, which is adapted to generate an additional polarization component due to symmetry breaking for a light wave confined in the resonator cavity having a light intensity exceeding a threshold intensity, wherein the polarization direction of the additional polarization component is orthogonal to an initial polarization component of the light wave coupled into the resonator cavity.

Another example of the disclosure relates to a polarization control device for providing an optical wave having a specific polarization. The polarization control device comprises a polarization alteration device according to an example, and an input adjustment element for adjusting the intensity and/or the central wavelength of a light wave coupled into the polarization alteration device, wherein the input adjustment element is configured to control the polarization of the part of the light wave coupled out of the resonator cavity by adjusting the power and/or central wavelength of the light wave coupled into the resonator cavity.

Yet another example of the disclosure relates to a polarization sensor for sensing a change of polarization direction of a light wave. The polarization sensor comprises a polarization alteration device according to an example. The polarization sensor further comprises a light source for coupling a linearly polarized light wave into the polarization alteration device, such that the intensity of the light wave confined in the resonator cavity of the polarization alteration device exceeds the threshold intensity of the Kerr nonlinearity, and a polarization analyzer for analyzing the polarization of the part of the light wave coupled out of the polarization alteration device and determining a change of the polarization of the light wave coupled into the resonator cavity of the polarization alteration device or confined within the resonator cavity of the polarization alteration device based on a measured change of the polarization of the light wave coupled out of the resonator cavity.

Yet another example of the disclosure relates to an electrooptical chip comprising a polarization alteration device and/or a polarization control device and/or a polarization sensor according to an example. The electrooptical chip may optionally be a miniaturized chip.

Yet another example of the disclosure relates to a method for adjusting the polarization of a light wave having a linear polarization. The method comprises coupling the light wave into a resonator cavity having a resonance mode at a resonance wavelength and a linewidth, wherein the resonator cavity exhibits no intensity-independent birefringence or an intensity-independent birefringence, whose effect on a light wave confined in the resonator is smaller than the linewidth of the resonance. The method further comprises increasing the intensity of the light wave confined in the resonator cavity such as to exceed a threshold intensity of a Kerr nonlinearity of the resonator cavity to generate an additional polarization component for the continuous light wave confined in the resonator cavity due to symmetry breaking, wherein the polarization direction of the additional polarization component is orthogonal to an initial polarization component of the light wave coupled into the resonator cavity.

Yet another example of the disclosure relates to a method for adjusting the polarization of a light wave having a central wavelength and linear polarization. The method comprises coupling the light wave into a resonator cavity having a resonance at a resonance wavelength and a linewidth, wherein the resonator cavity exhibits no intensity-independent birefringence or an intensity-independent birefringence, whose effect on the light wave confined in the resonator is less than the linewidth of the of the resonance. The method further comprises providing an intensity of the light wave confined in the resonator cavity such as to exceed a threshold intensity of a Kerr nonlinearity of the resonator cavity to generate an additional polarization component due to symmetry breaking, wherein the polarization direction of the additional polarization components is orthogonal to an initial polarization component of the light wave coupled into the resonator cavity. The method further comprises adjusting the central wavelength of the light wave coupled into the resonator cavity such as to overlap with one of several different resonance wavelengths split due to symmetry breaking.

Yet another example of the disclosure relates to a method for sensing a change of polarization direction of a light wave. The method comprises providing a resonator cavity having a resonance at a resonance wavelength and a linewidth, wherein the resonator cavity exhibits no intensity-independent birefringence or an intensity-independent birefringence, whose effect on the light wave confined in the resonator is less than the linewidth of the of the resonance. The method further comprises coupling the light wave into the resonator cavity such that the light wave is confined in the resonator cavity at an intensity exceeding a threshold intensity of a Kerr nonlinearity resulting in symmetry breaking. The method further comprises measuring the polarization of a part of the light wave coupled out of the resonator cavity and determining a change of the polarization of the light wave coupled into the resonator cavity or confined within the resonator cavity based on a measured change of the polarization of the light wave coupled out of the resonator cavity.

A light wave is a wave of electromagnetic radiation, also referred to as an optical wave. The terms light wave and optical wave are used as synonyms in this manuscript. The light wave may have visible and/or invisible spectral components. For instance, the light wave may have a central wavelength in the infrared, visible or ultraviolet spectral region. For instance, the light wave may have a central wavelength of 1.55 μm. The light wave comprises or consists of coherent light, wherein the coherence length is longer than the optical path of the light wave in a polarization alteration device according to an example. The light wave is optionally provided as a Laser radiation, optionally as a continuous Laser light wave.

The resonance mode of the resonator is a mode satisfying a resonance condition for an optical wave confined in the resonator having a specific wavelength. The linewidth of the resonance mode corresponds to the spectral width for which the resonance condition is satisfied. The resonance results in the optical wave establishing a standing wave within the resonator cavity.

The resonator cavity having no intensity-independent birefringence means that the optical wave confined in the resonator cavity does not experience any birefringence in the resonator cavity, which is independent of the light wave's intensity. In other words, the linear refractive index of the resonator cavity is identical for all polarization directions of the light wave confined in the resonator cavity. The resonator cavity may be configured to naturally exhibit no intensity-independent birefringence or may comprise additional means for cancelling the otherwise possible occurrence of intensity-independent birefringence of the resonator cavity. The alternatively allowed level of intensity-independent birefringence being smaller than the linewidth of the resonance mode means that any possibly remaining intensity-independent refringence is small enough not to significantly influence the resonance condition of the light wave confined in the resonator cavity. In particular, the possibly remaining intensity-independent birefringence is limited to a value not driving the confined light wave out of resonance with regard to the resonator cavity's resonance wavelength.

The resonator cavity having a Kerr nonlinearity means that the resonator cavity exhibits an intensity-dependent birefringence, wherein the intensity-dependent birefringence shows a noticeable effect for confined optical waves exceeding a threshold intensity. In other words, the Kerr nonlinearity provides the effect that the resonator cavity exhibits a birefringence, i.e., a refractive index depending on the polarization direction of the optical wave and depending on the intensity, for intensities of the optical wave exceeding the threshold intensity. The Kerr nonlinearity may be provided as a material property of an optical fiber or wave guide forming the resonator. For instance, materials having a centrosymmetric crystal structure and a high third order susceptibility may be suitable for providing a Kerr nonlinearity. Suitable materials for the resonator cavity and/or the optical fiber or the wave guide in general may be: fused silica, silicon nitride, aluminum nitride, calcium fluoride and magnesium fluoride. The Kerr nonlinearity affects the polarization of the light wave when the light wave's intensity exceeds the threshold intensity of the Kerr nonlinearity. Typical values for the threshold intensity in common materials are in a range, which may be achieved in high-Q resonators with input powers in the range of 1 μW to 100 mW.

Symmetry breaking means that a symmetry of the resonator cavity's resonance regarding the polarization direction of the confined optical wave is cancelled. In other words, while some or all resonance modes of the resonator cavity are degenerate regarding their polarization for intensities below the threshold intensity, i.e., the resonance modes are identical regarding their resonance wavelength for different polarization directions, but the resonance modes differ for different polarization directions when the intensity of the confined light wave exceeds the threshold intensity. In particular, the resonance modes may differ with respect to the resonance wavelength or resonance frequency for different polarization directions when the intensity of the confined optical wave exceeds the threshold intensity of the Kerr nonlinearity.

The initial polarization component relates to the polarization component(s) of the light wave coupled into the resonator cavity. The initial polarization component is described as a single component, although the polarization component may be described as comprising several components. The initial polarization component may be a linear polarization of a predetermined polarization direction.

A polarization control device is a device for maintaining or changing the polarization of an optical wave in a controlled manner. A polarization control device may be capable of changing a polarization direction and/or transforming a linear polarization into an elliptical and/or circular polarization and/or changing the handedness of elliptical or circular polarization. A polarization sensor is a device for sensing the polarization of an optical wave and/or a change of polarization of an optical wave.

The disclosure provides the advantage that it allows measuring changes of the polarization of an optical wave in a highly sensitive manner, which in turn allows providing polarization sensors having a high sensitivity. Moreover, the high sensitivity for measuring the polarization allows measuring other physical parameters in a highly sensitive manner, which have a direct or indirect influence on the polarization direction of the measured optical wave. For instance, a respective sensor may have an actuator element transforming the physical parameter to be determined, such as an electric and/or magnetic field, in a change of the polarization of the optical wave, which can then be determined in a highly sensitive manner.

Moreover, the disclosure provides the advantage that the embodiments may be provided in a compact and small configuration allowing a miniaturization of the embodiments. This in turn enables the use of such devices in photonic circuits and, hence, provides the option of sensing and/or controlling the polarization of an optical wave in such photonic circuits. In addition, examples may allow such a high degree of miniaturization to integrate polarization sensors and/or controllers in on-chip devices, such as photonic integrated circuits, and, hence, may facilitate optical communications and optical logic devices.

The disclosure further provides the advantage that it can be applied to optical waves having a moderate power and a moderate intensity and/or that the examples may be realized using optical waves having moderate a power and a moderate intensity. The use of a resonator cavity allows reaching intensities and powers of an optical wave confined within the resonator cavity allowing the exploitation of nonlinear optical effects, such as the Kerr effect, although the optical wave coupled into the resonator merely only has a moderate power and intensity. Thus, the disclosure may allow exploiting nonlinear optical effects, such as the Kerr effect, even for continuous optical waves having moderate powers. The disclosure therefore offers a nonlinear enhancement for the measurement and/or control of polarization for optical waves having moderate intensities, such as continuous waves.

According to an optional example, the resonator cavity exhibits at least two degenerate polarization resonance modes sharing the identical resonance wavelength at intensities below the threshold intensity and differing in their polarization direction or polarization handedness. In other words, several resonance modes for different polarization directions or polarization handedness are degenerate for intensities of the optical wave below the threshold intensity.

These degenerate polarization resonance modes split at an intensity of the light wave confined in the resonator cavity exceeding the threshold intensity for the Kerr nonlinearity. When split up, the resonance modes for different polarization directions or handedness may differ in their resonance wavelength. Thus, above the threshold intensity two or more optical waves sharing the same optical frequency but differing in their polarization direction or handedness will experience different resonance conditions, wherein the optical wave or component having a first polarization direction or handedness will be closer to the resonance condition of the resonator cavity than the optical wave or component having the second polarization direction or handedness but the same wavelength. This effect occurs due to the Kerr nonlinearity providing a different refractive index for the components or optical waves differing in their polarization direction or handedness. Accordingly, this provides the advantage that a selectivity of polarization direction and/or handedness may be provided by adjusting the intensity of the optical wave confined in the resonator. Moreover, this provides the advantage that the polarization direction or handedness of the optical wave in the resonator cavity and coupled out of the resonator cavity may be changed or switched with respect to the optical wave coupled into the resonator cavity by increasing the intensity or power of the optical wave confined in the resonator cavity over the threshold intensity.

According to an optional example, the resonator cavity further comprises at least two highly reflective mirrors. This allows effectively confining an optical wave in the resonator cavity to reach high powers and intensities even for optical waves coupled into the resonator cavity having only moderate power and intensity. Accordingly, this allows exploiting the Kerr nonlinearity by optical waves having only moderate power and intensity, such as continuous waves. Optionally the resonator cavity has a Finesse of at least 100. For instance, the resonator cavity may be a Fabry-Perot resonator cavity. The resonator cavity may be provided as a free space cavity comprising a nonlinear Kerr medium.

According to an optional example, the resonator cavity is adapted as a fiber cavity or as a wave guide cavity. This provides the advantage that the resonator cavity and the polarization alteration device may be adapted in a compact and stable manner. This facilitates a miniaturization of the polarization alteration device and may reduce the effect of external influences on the stability and function of the polarization alteration device. Moreover, such implementations may allow an integration of the polarization alteration device in a fiber-optical system. In addition, this allows providing a resonator cavity exhibiting the Kerr nonlinearity as a material option.

According to an optional example, the resonator cavity comprises two fiber Bragg mirrors as cavity minors. Such minors provide the advantage that a high reflectivity and, thus, a high Finesse of the resonator cavity can be achieved. Optionally the resonator cavity has a Finesse of at least 100. Moreover, fiber Bragg gratings offer the advantage that they may be integrated in the fiber of the fiber cavity and, thus, the resonator cavity and optionally the entire polarization alteration device may be integrated in one single fiber.

According to an optional example, the resonator cavity includes a fiber polarization controller for reducing or eliminating any intensity-independent birefringence of the resonator cavity. Such a fiber polarization controller allows effectively and efficiently adjusting the intensity-independent polarization conservation of the resonator cavity and, thus, to fulfill the criteria efficiently and effectively regarding the absence or restriction of the intensity-independent birefringence of the resonator cavity. Accordingly, the fiber polarization controller may ensure that essentially the only birefringence or polarization-alteration effect occurring in the resonator cavity originates in the intensity-dependent Kerr nonlinearity. The polarization controller may be configured to bend the optical fiber of the resonator cavity in a controlled manner so as to minimize the intensity-independent birefringence of the resonator cavity.

According to an optional example, the resonator cavity is or comprises a micro-resonator. This example provides the advantage that a highly compact and stable resonator cavity can be provided. Moreover, this example provides the advantage that a miniaturization of the resonator cavity and optionally the entire polarization alteration device is facilitated. Thus, optionally the polarization alteration device is integrated in a chip. The polarization alteration device integrated in a chip may for instance be provided by a section of the chip made of a material being susceptible to the electrooptic effect or the Faraday effect.

According to an optional example the polarization control device further comprises a light source, wherein the input adjustment element is configured to control the light source for adjusting the intensity and/or central wavelength of a light wave coupled into the polarization alteration device. This allows adjusting the intensity or power of the optical wave confined in the resonator cavity to selectively exceed or not exceed the threshold intensity of the Kerr nonlinearity. Accordingly, the alteration of the polarization of the optical wave coupled into and confined in the resonator cavity by generating an additional polarization component may be controlled by adjusting the intensity or power of the optical wave provided by the light source. This provides the option to change or control the polarization direction or handedness of an optical wave in particular in a photonic circuit. In particular when using diode lasers or any other electrically pumped laser source, the intensity of the optical wave emitted by the light source and, hence, the polarization of the optical wave coupled out of the resonator cavity may be adjusted by varying an electric current and/or a voltage applied to the light source, which consequently allows controlling the polarization by means of varying and controlling an electrical current or a voltage. According to an optional example of a polarization control device the light source is adapted to emit a continuous light wave. This allows providing a continuous optical wave for coupling into the resonator cavity.

It is understood by a person skilled in the art that the above-described features and the features in the following description and figures are not only disclosed in the explicitly disclosed examples and combinations, but that also other technically feasible combinations as well as the isolated features are comprised by the disclosure. In the following, several preferred examples and specific examples are described with reference to the figures for illustrating the disclosure without limiting the disclosure to the described examples.

In the following, background information about symmetry breaking, spontaneous symmetry breaking, and the Kerr nonlinearity is provided.

Spontaneous symmetry breaking (SSB) is an important concept in fundamental physics, explaining for instance the origins of bosonic mass via the Higgs mechanism, superconductivity and the phases of matter. SSB is characterized by a system whose Lagrangian and initial state are symmetric (invariant under some transformation), but whose lowest-energy states to which the system evolves do not share such symmetry.

Some nonlinear optical interactions have also exhibited SSB, such as time-reversal symmetry breaking in a pulse-pumped ring cavity; time-reversal symmetry breaking between optical solitons; and time-reversal symmetry breaking between the counter-propagating modes of a micro-resonator.

According to some examples of the disclosure, a novel form of SSB between the cross-circularly polarized components of linearly polarized input light to a fiber cavity with no birefringence is used. At low powers not exceeding a threshold intensity of the Kerr nonlinearity, the system maintains its symmetry such that the resonator cavity field's polarization matches the input light wave's polarization. However, above the threshold power or intensity, the nonlinear Kerr effect, also referred to as Kerr nonlinearity, leads to an instability such that the cavity polarization develops a handedness despite the input having no handedness.

These polarization interactions are mathematically analogous to those between counter-propagating light and so this effect can be similarly used for all-optical processing and storage of information(see for example the publications Del Bino, et al.: Symmetry Breaking of Counter-Propagating Light in a Nonlinear Resonator, Sci. Reports 7, 1-6, DOI: 10.1038/srep43142 (2017). 1607.01194; and Hill et al.: Effects of self- and cross-phase modulation on the spontaneous symmetry breaking of light in ring resonators. PHYSICAL REVIEW A 101, 13823, DOI: 10.1103/PhysRevA.101.013823 (2020)).

### BRIEF DESCRIPTION OF THE DRAWINGS

Further optional examples will be illustrated in the following with reference to the drawings.

FIG. 1 depicts a schematic illustration of a polarization alteration device according to an optional example.

FIG. 2 depicts in a schematic view a polarization sensor according to an optional example.

FIG. 3 schematically depicts a polarization sensor according to a further optional example.

FIG. 4 depicts in a schematic view a polarization control device according to an optional example.

FIG. 5 depicts an experimental configuration comprising a polarization control device 30 according to an optional example.

FIGS. 6A to 6C schematically illustrate the generation of a polarization component due to the Kerr nonlinearity of a resonator cavity.

FIG. 7 demonstrates the measured output power of different polarization modes depending on the detuning of the center frequency of the input light wave with respect to the resonance frequency of the resonator cavity.

### DESCRIPTION OF EXEMPLARY EMBODIMENTS

In the drawings the same reference symbols are used for corresponding or similar features in different drawings.

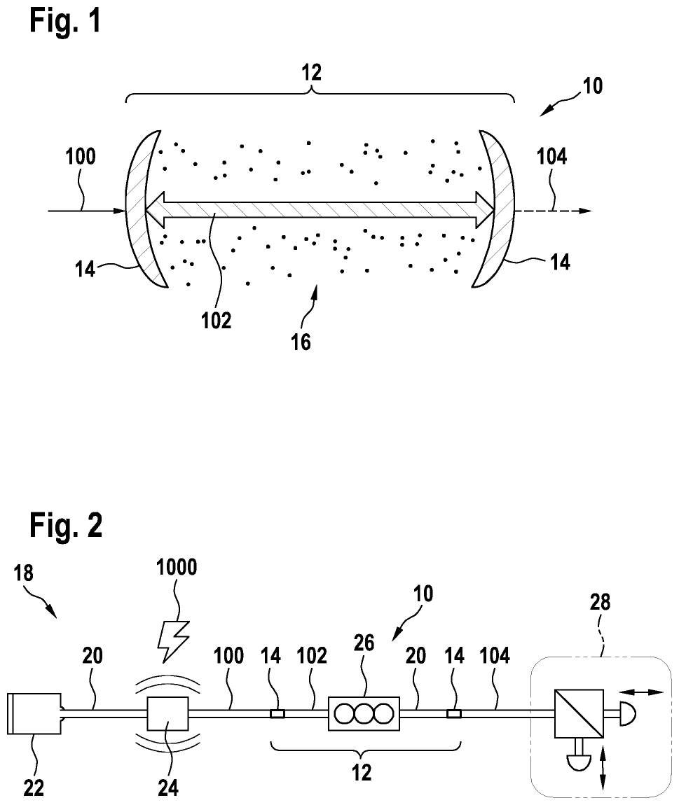

FIG. 1 depicts a schematic illustration of a polarization alteration device 10 according to an optional example. The polarization alteration device comprises a resonator cavity 12 having two concave mirrors 14. Inside the resonator cavity 12, a nonlinear Kerr medium 16 is provided which provides a Kerr nonlinearity for optical waves confined within the resonator cavity 12 exceeding a threshold intensity. According to the presented example, the Kerr medium 16 is distributed over the whole internal volume of the resonator cavity 12. However, according to other examples, the Kerr medium 16 may be arranged only in a part of the volume of the resonator cavity 12. The resonator cavity 12 exhibits no intensity-independent birefringence, but only a birefringence provided by the Kerr medium 16 for confined light waves exceeding the threshold intensity of the Kerr nonlinearity. Thus, the resonator cavity 12 only exhibits a birefringence, which is intensity-dependent and originates from the Kerr nonlinearity.

A light wave 100 of moderate power and intensity is coupled into the resonator cavity 12. The light wave 100 may be a coherent continuous wave, which is for instance provided by a light source based on a laser diode. The light wave 100, which is coupled into the resonator cavity 12 is partly confined within the resonator cavity 12 as a confined light wave 102 and only a small portion of the confined light wave 102 is coupled out as an output light wave 104. Since a large part of the incoupled light wave 100 is confined within the resonator cavity 12, the confined light wave 102 may reach a power and an intensity which by far exceeds the power and intensity of the input light wave 100 coupled into the resonator cavity 12. Optionally, a resonator cavity 12 having a Finesse of at least 100 is used, which allows reaching high powers and intensities of the confined light wave 102.

In particular, the confined light wave 102 may reach, depending on the set power of the input light wave 100 coupled into the resonator cavity 12, an intensity exceeding the threshold intensity of the Kerr nonlinearity. Thus, for moderate powers of the light wave 100 coupled into the resonator cavity 12, the resulting intensity of the confined light wave 102 may be below the threshold intensity of the Kerr nonlinearity and hence no birefringence occurs in the resonator cavity 12 for the confined light wave 102. Accordingly, for moderate powers of the input light wave 100 coupled into the resonator cavity 12, no additional polarization component is generated due to the Kerr nonlinearity. For higher powers (compared to the moderate power mentioned before) of the input light wave 100 coupled into the resonator cavity 12, the intensity of the light wave 102 confined in the resonator cavity 12 exceeds the threshold intensity of the Kerr nonlinearity. Accordingly, for higher powers of the light wave 100 coupled into the resonator cavity 12, the light wave 102 confined within the resonator cavity 12 experiences a birefringence due to the Kerr nonlinearity resulting in the generation of additional polarization components of the confined light wave 102 as compared to the light wave 100 coupled into the resonator cavity 12. The outcoupled light wave 104 corresponds to the confined light wave 102 with respect to its polarization properties and, thus, differs from the original input light wave 100 coupled into the resonator cavity 12.

When coupling a light wave 100 having a linear polarization into the resonator cavity 12 and when increasing the power of the light wave 100 coupled into the resonator cavity 12 to a level such that the light wave 102 confined in the resonator cavity 12 exceeds the threshold intensity of the Kerr nonlinearity, the Kerr effect leads to symmetry breaking and the generation of an additional polarization component having a polarization that is orthogonal to the initial polarization component of the light wave 100 coupled into the resonator cavity 12. Consequently, the overall polarization of the confined light wave 102 and the outcoupled light wave 104 corresponds to a circular or elliptical polarization, which differs from the linear polarization of the light wave 100 coupled into the resonator cavity. The linearly polarized input light wave 100 may be regarded as a superposition of a left and right circular polarized light and after the splitting of the resonance frequencies of the resonator cavity 12 due to the Kerr nonlinearity, one of these polarization handednesses satisfies the resonance condition in a better manner than the other handedness and, thus, becomes the dominant polarization handedness of the confined and outcoupled light waves 102 and 104. This polarization alteration occurring at intensities of the confined light wave 102 exceeding the threshold intensity of the Kerr nonlinearity can be reverted or stopped when reducing the intensity of the input light wave 100 coupled into the resonator cavity 12 such that the intensity of the light wave 102 confined within the resonator cavity drops below the threshold intensity, which accordingly terminates the splitting of the degenerated resonance modes.

Hence, the polarization alteration of the outcoupled light wave 104 relative to the input light wave 100 coupled into the resonator cavity 12 may be controlled by controlling the power of the input light wave 100 to cause the confined light wave 102 to exceed the threshold intensity or stay below the threshold intensity. Thus, the polarization may be for instance electrically controlled by merely controlling an electric current and/or an electric voltage controlling a light source providing the input light wave 100.

FIG. 2 depicts in a schematic view a polarization sensor 18 according to an optional example. The polarization sensor 18 may be used to measure the polarization or change of polarization of an input light wave 100 or to measure a different physical quantity by measuring the effect of said quantity on the polarization of the input light wave 100.

The polarization sensor 18 comprises a polarization alteration device 10. The polarization alteration device 10 is integrated in an optical fiber 20 or a waveguide, wherein a resonator cavity 12 of the polarization alteration device 10 is formed by a part of the optical fiber 20 or wave guide extending between two resonator mirrors 14. According to the presented example, the resonator mirrors 14 are Bragg mirrors integrated into the optical fiber 20 or wave guide. The resonator cavity 12 is further controlled by a polarization controller 26, which eliminates any intensity-independent birefringence of the resonator cavity 12 or suppresses the intensity-independent birefringence below a predetermined limit, such that the effect of the intensity-independent birefringence of the resonator cavity 12 on the confined light wave 102 is smaller than the linewidth of the resonance mode. Other parts of the nonlinear optical fiber 20 or wave guide outside the resonator cavity 12 may optionally be equipped with one or more polarization controllers (show in FIG. 2) to eliminate, suppress, or control the respective intensity-independent birefringence.

The polarization sensor 18 further comprises a light source 22 providing an input light wave 100, which is coupled into the resonator cavity 12. The light source 22 and also other optical components of the polarization sensor 18 are connected to the optical fiber 20 or wave guide, such that the polarization sensor 18 forms a fiber optical system. Between the light source and the resonator cavity 12, an actuator element 24 may be arranged, which transforms an external impact caused by a physical quantity or parameter to be measured into a change of the polarization of the light wave 100, which is coupled into the resonator cavity 12. For example, such an actuator element 24 may be adapted to cause a change of the polarization of the transmitted light wave 100 in response to an external electrical and/or magnetic field, to which the actuator element 24 is exposed. Due to the high sensitivity of the polarization sensor 18, the physical quantity or parameter or a change of said parameter or quantity can be measured or determined in a highly sensitive manner. The actuator element 24 may for example be based on the electro-optical effect, the Faraday effect and/or a geometrical change of the wave guide, for instance due to mechanical strain.

The outcoupled output light wave 104 is guided by the optical fiber 20 or wave guide to a polarization analyzer 28 for analyzing the polarization of the outcoupled light wave 104 and/or determining a change of the polarization of the outcoupled light wave 104.

For instance, the polarization sensor 18 may be operated by sweeping the power of the light wave 100 provided by the light source 22 from a first value to a second value, wherein the power and intensity of the light wave 102 confined in the resonator cavity 12 is below the threshold intensity of the Kerr nonlinearity when the light source 22 emits the light wave 100 with a power having the first value, and wherein the power and intensity of the light wave 102 confined in the resonator cavity 12 is above the threshold intensity when the light source 22 emits the light wave 100 with a power having the second value and a linear polarization having a predetermined direction. The sweep may be carried out by controlling the emission intensity of the light source 22 and/or by gradually attenuating the light wave 100 between the light source 22 and the resonator cavity. Accordingly, during each sweep the intensity and power of the light wave 102 confined in the resonator cavity 12 changes from a mode in which a spontaneous symmetry breaking due to the Kerr nonlinearity is prohibited to a mode, in which it is allowed and may spontaneously occur. The polarization sensor 18 may be configured, such that when no impact of an external physical parameter or disturbance 1000 on the polarization of the input light wave 100 is present, the symmetry breaking due to the Kerr nonlinearity occurs spontaneously in each sweep, i.e., the symmetry breaking occurs such that the handedness of the generated circular or elliptical polarization randomly occurs in both directions. Thus, in the absence of external impacts or disturbances 1000, the dominating handedness of the circular or elliptical polarization occurring due to symmetry breaking statistically occur with the same likelihood. However, when an external impact on or disturbance 1000 of the polarization direction of the input light wave 100 is present, this symmetry is broken, which will result in the symmetry breaking not occurring in a random manner anymore. Instead, the dominating handedness of the circular or elliptical polarization may not be statistically equally distributed but a preferred direction may prevail. This effect may be used to sense the external impact or disturbance 1000 on the polarization direction of the input light wave 100 in a highly sensitive manner. The sensitivity is further increased by the self-amplification of the symmetry breaking, since the circularly polarized light wave 102 confined in the resonator cavity 12 having the dominating handedness drives the component of the light wave 102 having the other polarization direction further out of resonance.

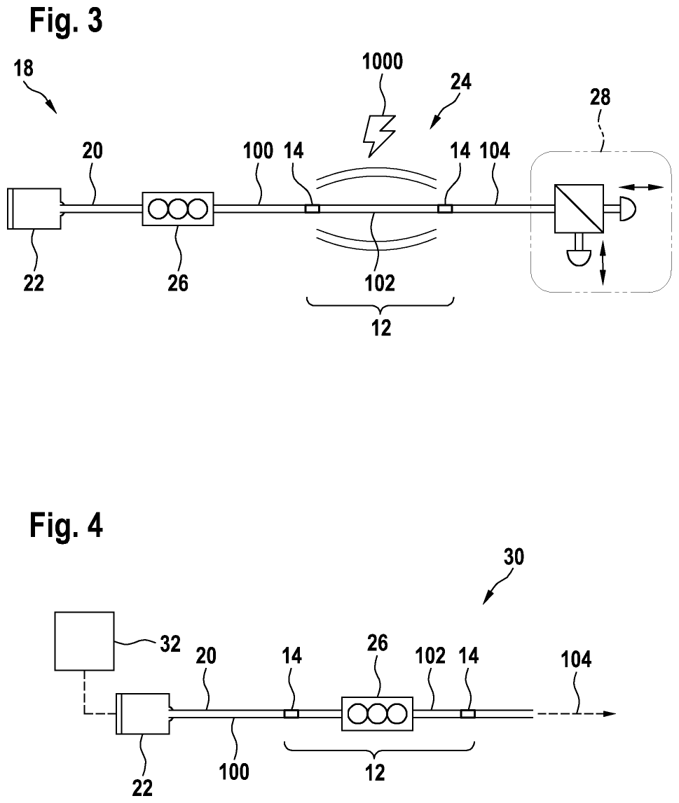

FIG. 3 schematically depicts a polarization sensor 18 according to an optional example corresponding in most features to the example shown in FIG. 2. The example shown in FIG. 3, however, differs from the example of FIG. 2 in that the resonator cavity 12 is configured as the actuator element 24 and the polarization controller 26 is arranged at a part of the nonlinear wave guide 20 outside the resonator cavity 12. This example allows sensing an external impact or disturbance 1000 acting directly on the resonator cavity 12 by measuring a change in polarization of the outcoupled light wave 104. Such an external impact or disturbance 1000 on the resonator cavity may for instance influence the intensity-independent birefringence of the resonator cavity 12, which in the absence exhibits no intensity-independent birefringence or an intensity-independent birefringence smaller than the linewidth of the of the resonance mode. This intensity-independent birefringence provoked by the external impact or disturbance 1000, thus, results in an unequal statistical distribution of the dominating handedness of the elliptical or circular polarization generated by symmetry breaking when exceeding the threshold intensity of the Kerr nonlinearity. The external impact or disturbance 1000 causing such a change or occurrence of an intensity-independent birefringence may for example be a mechanical strain bending the optical fiber 20 or wave guide, to which the resonator cavity 12 is exposed, and/or an electrical field influencing the polarization in the resonator cavity 12 due to the Faraday effect.

To allow such influences on the birefringence of the resonator cavity 12 or the polarization of the light wave 102 confined in the resonator cavity and to limit or avoid intensity-independent birefringence of the nonlinear wave guide outside the, the polarization controller 26 is arranged at a part of the nonlinear waveguide 20 outside the resonator cavity 12.

FIG. 4 depicts in a schematic view a polarization control device 30 according to an optional example. The polarization control device 30 allows controlling the polarization of the light wave 104, i.e., maintaining the polarization unchanged or switching the polarization.

The polarization control device 30 comprises a nonlinear wave guide 20 including a resonator cavity 12, wherein the resonator cavity is formed by a part of the nonlinear wave guide 20 and two resonator mirrors 14. The polarization control device 30 further comprises a polarization controller 26 eliminating or minimizing the intensity-independent birefringence of the resonator cavity 12. Furthermore, the polarization control device 26 comprises a light source 22 providing a coherent light wave 100 to the nonlinear wave guide 20, which is then coupled into the resonator cavity 12. A confined light wave 102 is built up within the resonator cavity 12, which in dependence of the power of the light wave 100 provided by the light source and coupled into the resonator cavity 12 stays below or exceeds the threshold intensity of the Kerr nonlinearity of the resonator cavity. Accordingly, by adjusting the output power of the light source 22, for which a separate control unit 32 may be provided, the intensity of the light wave 102 confined in the resonator cavity 12 can be adjusted. Consequently, the polarization control device 30 allows controlling the polarization of the outcoupled wave 104 by either adjusting the output power of the light source 22 such that the power or intensity of the confined light wave 102 does not exceed the threshold intensity, which will result in the outcoupled light wave 104 having the same polarization as the input wave 100 coupled into the resonator cavity 12, or by adjusting the output power of the light source 22 such that the resulting power or intensity of the light wave 102 confined in the resonator cavity exceeds the threshold intensity. The latter will result in the occurrence of symmetry breaking due to the Kerr nonlinearity and, thus, in the generation of additional polarization components being at least partly orthogonal to the polarization component of the initial output of the light source 12. For the input light wave 100 having a linear polarization, the polarization of the outcoupled light wave 104 may then have a circular or elliptical polarization comprising polarization components being orthogonal to the initial linear polarization.

The symmetry breaking due to the Kerr nonlinearity may spontaneously occur when exceeding the intensity threshold resulting in an arbitrary handedness and a statistically equal distribution of the handedness of the resulting elliptical or circular polarization for a large number of polarization switching processes. However, the polarization control device 30 may be configured to provoke a polarization switching in a preferred or predetermined direction, i.e., the resulting elliptical or circular polarization of the outcoupled light wave having a preferred or predetermined handedness. This may for instance be achieved by modifying the central wavelength of the light wave 100 provided by the light source 22 to detune the central wavelength with respect to the wavelength of the degenerate resonance modes (below the threshold intensity) such as to have a closer match with the wavelength of the one resonance mode (after resonance mode splitting above the threshold intensity) having the preferred polarization handedness. The detuning of the central wavelength of the may for example be achieved by using a spectrally tunable light source and/or by spectral filtering of the input light wave 100.

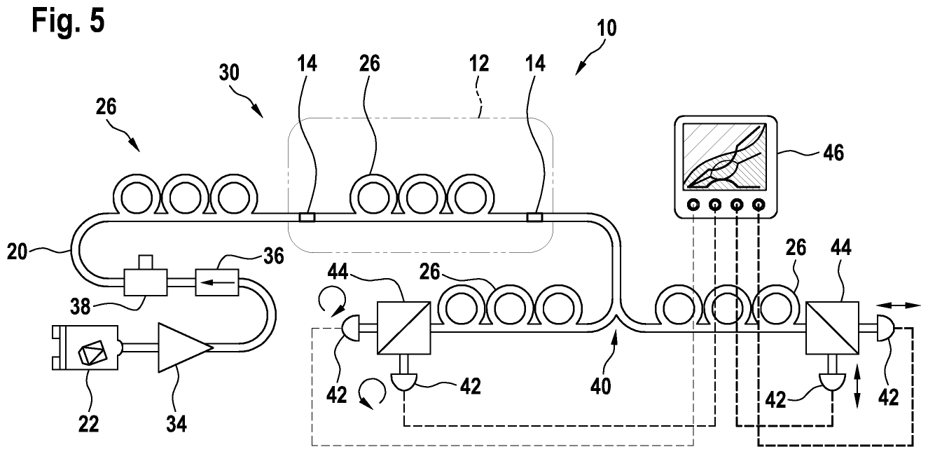

FIG. 5 depicts an experimental configuration comprising a polarization control device 30 according to an optional example. The polarization control device 30 comprises a polarization alteration device 10 according to an optional example having a resonator cavity 12. According to this example, the resonator cavity 12 is a Fabry-Perot cavity made of an optical fiber 20 having two high-finesse fiber Bragg mirrors as cavity mirrors 14. To ensure degenerate polarization resonance modes, the optical fiber 20 of the resonator cavity 12 is set inside a polarization controller 26 to minimize intensity-independent birefringence in the optical fiber 20 of the resonator cavity 12 and the resonator mirrors 14. A light wave is input to the resonator cavity 12 from a light source 22 comprising tunable diode laser via an erbium-doped fiber amplifier 34, with an optical isolator 36 used to prevent undesired effects due to back reflections. A variable attenuator 38 is then used to control the power of the input light wave and its polarization is maintained via a polarization controller 26. The polarization alteration device 10 corresponds to the polarization alteration device 10 as described with reference to the polarization control device 30 of FIG. 4. The outcoupled light wave output of the polarization alteration device 10 is split by a 50:50 fiber coupler 40 and each branch is directed to photo diodes 42 via a further polarization controller 26 and polarization beam splitter 44. These final polarization controllers are used to map the resonator cavity polarization basis states to the polarization beam splitter 40 such that the photo diodes 42 each monitor a different polarization state. The signals of the photo diodes 42 are observable with an oscilloscope 46. This experimental configuration allows observing the operation of the polarization control device and the occurrence of spontaneous symmetry splitting.

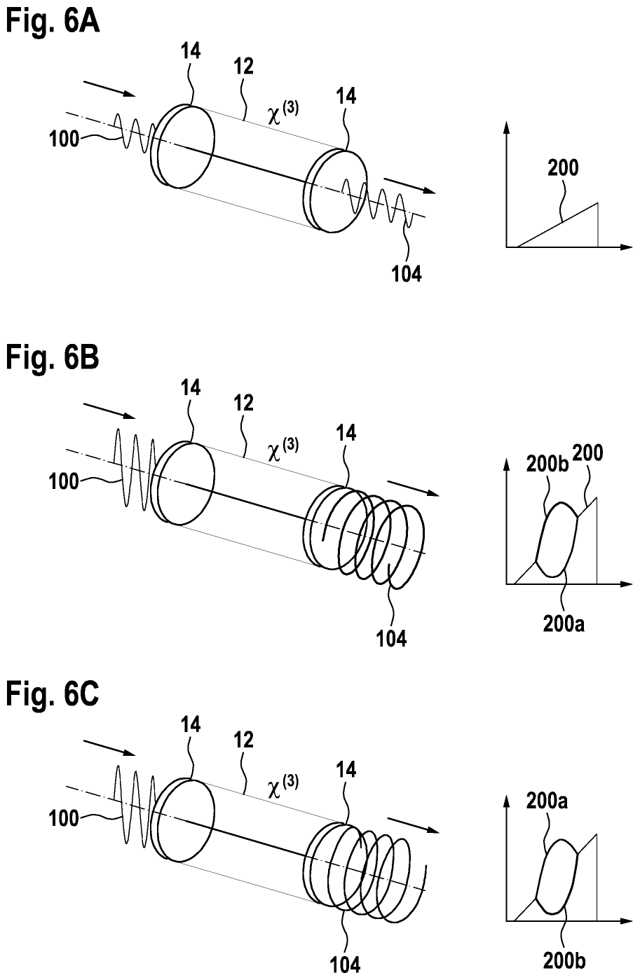

With reference for FIGS. 6A-C and 7, theoretical background information and an illustration of the polarization controlling and alteration using an experimental configuration, as shown in FIG. 5, are presented, without the disclosure being limited to these examples.

Nonlinear interactions of light are extremely weak and are normally only appreciable in high-power laser systems, or those in which the intensity is resonantly enhanced. The advent of high-Q ring and Fabry-Perot (FP) cavities has led to extensive research in nonlinear optics at low powers and small footprints, promising future application in photonic circuits (see for example Liu et al.: Ultralow-power chip-based soliton microcombs for photonic integration, Optics InfoBase Conference Papers, vol. Part F160-, 1347-1353, DOI: 10.1364/optica.5.001347 (OSA—The Optical Society, 2019) 1805.00069; and Brasch et al.: Nonlinear filtering of an optical pulse train using dissipative Kerr solitons; Optic a 6, 1386, DOI: 10.1364/optica.6.001386 (2019), 1907.09715).

The evolution of the electric field inside a resonator consisting of a nonlinear Kerr medium having a considerable third order electrical susceptibility x⁽³⁾ is given by the Lugiato-Lefever Equation (see Lugiato, L. A. & Lefever, R.: Spatial Dissipative Structures in Passive Optical Systems. Tech. Rep. (1987)), which is here normalized, ignores dispersive effects, and is extended to include coupled polarization effects:

$$\frac{\partial {E}_{\pm }}{\partial t} = {\tilde{E}}_{\pm } - {E}_{\pm } + i δ {E}_{\pm } - i ( {\vert {E}_{\pm } \vert}^{2} + 2 {\vert {E}_{\pm } \vert}^{2} ) {E}_{\pm } \qquad ( 1 )$$

in which the subscript+(—) denotes the right-(left-) handed circular polarization, the first term represents the input field to the resonator cavity, the second represents losses inside the resonator cavity, the third represents the field-cavity detuning and the final term represents the Kerr effect.

The final two terms of equation (1) are of the same form and can be taken together as an effective cavity detuning. This is fitting with the physical manifestation of the Kerr nonlinearity in this system as an intensity dependent refractive index in which the effective refractive index that a beam experiences is dependent on its own intensity, via self-phase modulation (SPM), and the intensity of the cross-polarized beam, via cross-phase modulation (CPM). When the Kerr effect is a result of non-resonant electronic response, as in a nonlinear wave guide comprising a silica fiber at 1550 nm, the effect of CPM is twice that of SPM, giving the factor of 2 in equation (1).

The symmetry of equation (1) can be seen by interchanging the ±indices, providing that the inputs to both modes are equal (\tilde{E}₊=\tilde{E}₋), i.e., a linearly polarized input. FIG. 6A shows the expected symmetric response of a polarization controller according to an example of the disclosure to a linearly polarized input whose frequency or central wavelength is swept over a resonance. Kerr and thermal nonlinearities give the resonance a triangular shape, as can be seen in the graph on the right-hand side presenting the intracavity power over the spectral detuning between the central wavelength of the confined light wave and the resonance wavelength. The symmetry in the system ensures that both cross-polarized components of the input couple equally, preserving the polarization of the input, i.e., preserving the linear polarization for the intracavity power and intensity below the threshold intensity of the Kerr nonlinearity. The resonance appears to have a triangular shape as a result of thermal heating of the resonator and/or the Kerr effect, which shifts the resonance frequency when light is coupled into the resonator cavity.

However, above threshold power and threshold intensity, and for a range of detunings, this symmetric state becomes unstable due to the differing magnitudes of SPM and CPM (see FIGS. 6B and 6C). Under these conditions, any small difference in intensity is amplified as the stronger mode drives the weaker further out of resonance via CPM. FIG. 6B shows how the amplification of systematic noise leads the system to spontaneously adopt a handedness at random, with one mode dominating over this range. At a first glance it might appear as if this system has broken conservation of angular momentum, as the input has no angular momentum but the cavity field has a handedness. This is not the case, instead the linearly polarized input has been broken into its constituent components of opposite angular momenta, with one dominating the coupling into the cavity. The opposite handedness is rejected from the cavity, but still exists, conserving angular momentum. This process can also be viewed as the spontaneous generation of light of an orthogonal polarization to the input. The input to the resonator cavity is vertically linearly polarized, so has no horizontal component. However, the resulting cavity/output fields are elliptically polarized, which now must have a horizontal component either ±π out of phase with the vertical component. Accordingly, the process can be characterized by either the difference in the output intensities in the circular basis, or by the generation of light in the horizontal basis.

As depicted in FIG. 6A, linearly polarized light enters a high quality, nonlinear Fabry-Perot resonator cavity 12 having degenerate polarization resonance modes. Below the threshold power and threshold intensity, the resonator cavity 12 equally supports all polarization states and the output polarization matches the input polarization. As shown in FIGS. 6B and 6C, for powers and intensities above the threshold power and intensity, there exists a regime in which the resonator cannot simultaneously support both cross-circular polarization modes. This leads to a spontaneous symmetry breaking in which the output develops an angular momentum of given magnitude but random handedness, even though the input and system both have zero angular momentum. The scenario presented in FIG. 6C differs from the scenario presented in FIG. 6B by the dominant handedness. While in FIG. 6B the counter-clockwise handed polarization mode is dominant and drives the clockwise handed polarization mode out of resonance, the situation is opposite in the scenario shown in FIG. 6C, where the clockwise handed polarization mode is dominant. Accordingly, the graphs in FIGS. 6B and 6C presenting the stored intracavity power 200 split up when looking only at one of the individual polarization modes. While in FIG. 6B the intracavity power of the clockwise handed polarization mode 200a is reduced and the counter-clockwise handed polarization mode 200b is increased, the situation is opposite in the scenario presented in FIG. 6C.

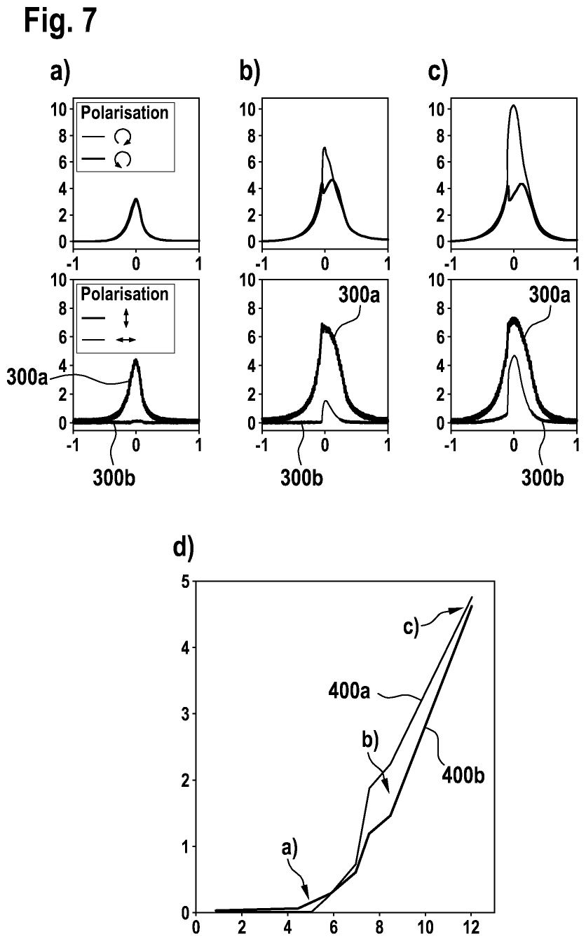

FIG. 7 schematically demonstrates the measured output power in mW of the different polarization modes depending on the detuning of the center frequency of the input light wave with respect to the resonance frequency of the resonator cavity in MHz (sections a) to c)). In section a), the input light wave has a low power, such that the intracavity power is below the threshold power of the Kerr nonlinearity. In this case both the right- and left-handed polarization states couple equally into the cavity. This corresponds to the output light always having linear vertical polarization 300a, just as the input light wave, with the orthogonal horizontal polarization component 300b being zero. In section b), the input power is high, such that the intracavity power is above the threshold. In this case, there is spontaneous symmetry breaking in the cross-circular polarization modes for some range of cavity detuning. In this regime, there the spontaneous generation of a horizontally polarized light component 300b is generated, at the expense of the initial vertical polarization component 300a. In section c), a case is shown in which these effects develop further for higher input powers, with the asymmetric splitting magnitude increasing along with the power of the spontaneously generated light 300b.

Section d) of FIG. 7 shows the polarization splitting power 400a (vertical axis, in mW) and the power 400b (vertical axis, in mW) of the orthogonal polarization component 300b generated due to the Kerr nonlinearity in dependence of the input power (horizontal axis, in mW). A threshold response for both the spontaneous splitting and generation can be seen with respect to input power having an onset at about 5.5 mW.

### LIST OF REFERENCE SYMBOLS

10 polarization alteration device
12 resonator cavity
14 resonator minor
16 nonlinear Kerr medium
18 polarization sensor
20 optical fiber or wave guide
22 light source
24 actuator element
26 polarization controller
28 polarization analyzer
30 polarization control device
32 control unit
34 fiber amplifier
36 optical isolator
38 variable attenuator
40 50:50 fiber coupler
42 photo diode
44 polarization beam splitter
46 oscilloscope
100 light wave coupled into the resonator cavity
102 light wave confined in the resonator cavity
104 light wave coupled out of the resonator cavity
200 intracavity power
200a intracavity power of clockwise handed polarization mode
200b intracavity power of counter-clockwise handed polarization mode
300a output power of vertical linear polarization
300b output power of horizontal linear polarization
1000 external impact or disturbance

1. A polarization alteration device, comprising a resonator cavity having a resonance mode at a resonance wavelength and a linewidth, wherein the resonator is configured to:
exhibit no intensity-independent birefringence or an intensity-independent birefringence, whose effect on a light wave confined in the resonator cavity is smaller than the linewidth of the resonance mode; and
exhibit a Kerr nonlinearity, which is adapted to generate an additional polarization component due to symmetry breaking for a light wave confined in the resonator cavity having a light intensity exceeding a threshold intensity, wherein a polarization direction of the additional polarization component is orthogonal to an initial polarization component of the light wave coupled into the resonator cavity.

2. The polarization alteration device according to claim 1, wherein the resonator cavity exhibits at least two degenerate polarization resonance modes sharing an identical resonance wavelength at intensities below the threshold intensity and differing in their polarization direction or polarization handedness.

3. The polarization alteration device according to claim 2, wherein degenerate polarization resonance modes split at an intensity of the light wave confined in the resonator cavity exceeding the threshold intensity for the Kerr nonlinearity.

4. The polarization alteration device according to claim 1, wherein the resonator cavity further comprises at least two highly reflective mirrors.

5. The polarization alteration device according to claim 1, wherein the resonator cavity is adapted as a fiber cavity or as a waveguide cavity or as a free space cavity comprising a nonlinear Kerr medium.

6. The polarization alteration device according to claim 1, wherein the resonator cavity comprises two fiber Bragg mirrors as cavity minors.

7. The polarization alteration device according to claim 1, wherein the resonator cavity includes a fiber polarization controller for reducing or eliminating any intensity-independent birefringence of the resonator cavity.

8. The polarization alteration device according to claim 1, wherein resonator cavity is or comprises a micro-resonator.

9. The polarization alteration device according to claim 1, wherein the resonator cavity has a Finesse of at least 100.

10. The polarization alteration device according to claim 1, wherein the polarization alteration device is integrated in a chip.

11. A polarization control device for providing an optical wave having a specific polarization, the polarization control device comprising:
a polarization alteration device according to claim 1; and
an input adjustment element for adjusting the intensity and/or a central wavelength of a light wave coupled into the polarization alteration device, wherein the input adjustment element is configured to control the polarization of a part of the light wave coupled out of the resonator cavity by adjusting a power and/or central wavelength of the light wave coupled into the resonator cavity.

12. The polarization control device according to claim 11, further comprising a light source, wherein the input adjustment element is configured to control the light source for adjusting the intensity and/or central wavelength of a light wave coupled into the polarization alteration device.

13. The polarization control device according to claim 12, wherein the light source is adapted to emit a continuous light wave.

14. A polarization sensor for sensing a change of polarization direction of a light wave, the polarization sensor comprising:
the polarization alteration device according to claim 1;
a light source for coupling a linearly polarized light wave into the polarization alteration device, such that the intensity of the light wave confined in the resonator cavity of the polarization alteration device exceeds the threshold intensity for the Kerr nonlinearity; and
a polarization analyzer for analyzing the polarization of a part of the light wave coupled out of the polarization alteration device and determining a change of the polarization of the light wave coupled into the resonator cavity of the polarization alteration device or confined within the resonator cavity of the polarization alteration device based on a measured change of the polarization of the light wave coupled out of the resonator cavity.

15. The polarization sensor according to claim 14, wherein the light source is adapted to couple a continuous light wave into the polarization alteration device.

16. An electrooptical chip comprising the polarization alteration device according to claim 1; and/or a polarization control device comprising:
the polarization alteration device; and
an input adjustment element for adjusting the intensity and/or a central wavelength of a light wave coupled into the polarization alteration device, wherein the input adjustment element is configured to control the polarization of a part of the light wave coupled out of the resonator cavity by adjusting a power and/or central wavelength of the light wave coupled into the resonator cavity; and/or
a polarization sensor comprising:
the polarization alteration device;
a light source for coupling a linearly polarized light wave into the polarization alteration device, such that the intensity of the light wave confined in the resonator cavity of the polarization alteration device exceeds the threshold intensity for the Kerr nonlinearity; and
a polarization analyzer for analyzing the polarization of a part of the light wave coupled out of the polarization alteration device and determining a change of the polarization of the light wave coupled into the resonator cavity of the polarization alteration device or confined within the resonator cavity of the polarization alteration device based on a measured change of the polarization of the light wave coupled out of the resonator cavity.

17. A method for adjusting a polarization of a light wave having a linear polarization, the method comprising:
coupling the light wave into a resonator cavity having a resonance mode at a resonance wavelength and a linewidth, wherein the resonator cavity exhibits no intensity-independent birefringence or an intensity-independent birefringence, whose effect on a light wave confined in the resonator is smaller than the linewidth of the resonance; and
increasing an intensity of the light wave confined in the resonator cavity such as to exceed a threshold intensity for a Kerr nonlinearity of the resonator cavity to generate an additional polarization component for the light wave confined in the resonator cavity due to symmetry breaking, wherein a polarization direction of the additional polarization component is orthogonal to an initial polarization component of the light wave coupled into the resonator cavity.

18. A method for adjusting a polarization of a light wave having a central wavelength and linear polarization, the method comprising:
coupling the light wave into a resonator cavity having a resonance at a resonance wavelength and a linewidth, wherein the resonator cavity exhibits no intensity-independent birefringence or an intensity-independent birefringence, whose effect on the light wave confined in the resonator is less than the linewidth of the of the resonance;
providing an intensity of the light wave confined in the resonator cavity such as to exceed a threshold intensity of a Kerr nonlinearity of the resonator cavity to generate an additional polarization component due to symmetry breaking, wherein a polarization direction of the additional polarization components is orthogonal to an initial polarization component of the light wave coupled into the resonator cavity; and
adjusting the central wavelength of the light wave coupled into the resonator cavity such as to overlap with one of several different resonance wavelengths split due to symmetry breaking.

19. The method for adjusting the polarization of a light wave according to claim 17, wherein the light wave is a continuous light wave.

20. A method for sensing a change of a polarization direction of a light wave, the method comprising:
providing a resonator cavity having a resonance at a resonance wavelength and a linewidth, wherein the resonator cavity exhibits no intensity-independent birefringence or an intensity-independent birefringence, whose effect on the light wave confined in the resonator is less than the linewidth of the of the resonance;
coupling the light wave into the resonator cavity such that the light wave is confined in the resonator cavity at an intensity exceeding a threshold intensity for a Kerr nonlinearity resulting in symmetry breaking; and
measuring the polarization of a part of the light wave coupled out of the resonator cavity and determining a change of the polarization of the light wave coupled into the resonator cavity or confined within the resonator cavity based on a measured change of the polarization of the light wave coupled out of the resonator cavity.
